(19) United States
(12) Patent Application Publication
(10) Pub. No.: US 2011/0228388 A1
(43) Pub. Date: Sep. 22, 2011

(54) STEREOSCOPIC KALEIDOSCOPE AND 3D VIEWER

(76) Inventor: Michael Kory, Malibu, CA (US)

(21) Appl. No.: 13/014,687

(22) Filed: Jan. 26, 2011

Related U.S. Application Data
(60) Provisional application No. 61/298,358, filed on Jan. 26, 2010.

(51) Int. Cl. G02B 27/24; G02B 27/08; G02B 27/02

(52) U.S. Cl. 359/471; 359/616; 359/617; 359/482

(57) ABSTRACT

A binocular kaleidoscope for the purpose of combining the field of repeating patterns associated with kaleidoscopes with stereopsis. A mirror chamber with an object window at the distal end and viewing lenses at the proximal end is utilized, which provides stereopsis covering the entire visual field of both the source material and its reflections. Real depth is provided in an embodiment utilizing physical material such as beads or liquids contained in one or more stacked transparent compartments as the source imagery. Virtual depth is provided in an embodiment utilizing stereoscopic video as the source imagery, in which case a mirrored divider bisects the mirror chamber. The video can be either be previously produced footage or generated in real time by software which can be interactively manipulated by the user in order to change programs or such parameters as color, motion and timing. A handheld device can be used to display the video. The stereoscopic video kaleidoscope described herein may also be adapted for use as a stereoscopic 3D viewer.

This patent application claims priority from U.S. Provisional Patent Application No. 61/298,358, filed on Jan. 26, 2010.

### TECHNICAL FIELD

The following relates to kaleidoscopes, specifically to stereoscopic kaleidoscopes and viewers.

### BACKGROUND

Since it was invented by Sir David Brewster in 1815, the kaleidoscope has continued to fascinate generation after generation of children and adults. The ability to peer into the eyepiece of a simple and small device and discover and manipulate a seemingly endless field of ever-changing symmetrical patterns is something that has always had widespread appeal.

In its most basic form, the kaleidoscope consists of a tube encasing three elongated mirrors creating a triangular column. One end of the column forms an object window abutting a transparent rotating chamber containing an assortment of colorful bits of plastic or glass; this serves as the source material to be viewed and reflected. The other end of the column serves as the eyepiece. When viewed through the eyepiece, the triangular aperture of the object window affords a direct view of the source material behind it, and the surrounding mirrors produce a repeating pattern of multiple reflections of that image. The direct view and the reflections of it combine to produce a field of patterns extending to the edges of peripheral vision. However, since only one eye is afforded this view, the imagery produced is flat, or two-dimensional.

Several binocular kaleidoscopes in the prior art have introduced binocular viewing into kaleidoscope design. The term “binocular” however only refers to the use of both eyes, and does not necessarily imply stereopsis, or the sensation of depth. If a viewer uses both eyes to view essentially flat subject matter such as a photograph of a car, the amount of depth perceived is obviously limited in comparison to looking at the actual car. The more depth the subject matter has, the more parallax—i.e., the difference in the perceived position of a 3D object when viewed by the left vs. the right eye—there is, and the more depth that can be perceived. Of the previous binocular kaleidoscopes in the prior art none take full advantage of the possibilities of stereopsis.

In the case of U.S. Pat. No. 4,820,004 (Briskin), no mention is made of dimensional source material, no lenses are suggested to aid in focusing, no claims are made for stereopsis, and little would be possible because of the greatly reduced parallax inherent in the design. In the case of U.S. Pat. No. 5,020,870 (Gray), the source material on the disks or dishes suggested is either essentially flat or are not deep enough to introduce parallax, consequently only the internal reflections would provide any stereopsis. In the case of U.S. Pat. No 5,475,532 (Sandoval et al.), no lenses are suggested to aid in focusing, and the arrangement of mirrors and windows allows for stereopsis only in a version large enough to be able to view through a single window with both eyes, necessitating a substantially larger and unwieldy device, and any subsequent stereopsis would be almost entirely comprised of the internal reflections as opposed to imagery framed by the windows. In the case of Int. Pat. No. 03/083516 (Wallach), no lenses are suggested to aid in focusing, and the only source material suggested are either a flat disk or a flat container, eliminating the possibility of significant parallax. In addition, the arrangement of two triangular cross-sectioned eye channels at an angle to one another could only produce stereopsis in a limited, harlequin-patterned portion of reflections covering only one third of the total viewing area.

In addition, these binocular kaleidoscopes all rely on physical objects as the source material to be reflected. Another possibility unexplored by them is to utilize stereoscopic imagery or video as the source material.

Several video kaleidoscopes in the prior art have been proposed, namely: U.S. Pat. No. 4,731,666 (Csesznegi);U.S. Pat. No. 6,062,698 (Lykens); and U.S. Pat. No. 7,399,083 (Bailey et al.). However, these are monocular and/or do not utilize stereoscopic source material, and therefore cannot produce stereoscopic patterns based on the source material.

Thus advantages of one or more aspects of the present invention are to incorporate source material providing sufficient parallax for significant stereopsis, and stereo viewing of both that source material and its internal reflections covering the entire foveal or central region of vision. In addition to stereopsis, an advantage of binocular viewing over monocular viewing is that small children have difficulty viewing material with one eye rather than two. Other advantages of one or more aspects are to provide for a device that is small, portable, handheld, simple, and inexpensive to manufacture. These and other advantages of one or more aspects will become apparent from a consideration of the ensuing description and accompanying drawings.

### SUMMARY

The primary objective of the stereoscopic kaleidoscope described herein is to improve on the visual experience associated with kaleidoscopes by giving it depth and making it more immersive.

This is achieved by means of a mirror chamber consisting of two or more inwardly reflecting mirrored surfaces lining the interior of a viewing apparatus. This chamber opens to an object window at one end, and the opposing end houses two eyepiece lenses.

In one embodiment utilizing physical materials such as beads as the source material, the entire viewing field allows for stereopsis. In another embodiment utilizing stereoscopic video as the source, the central vertical column of reflections occupying the field of vision most sensitive to stereopsis will be entirely correct (as will every other column of reflections to either side of the central column). Adjacent alternating columns of reflections will have reverse stereopsis (near and far portions of the image will be reversed), although these columns will appear in peripheral vision, which is not sensitive to stereopsis; consequently, this will not be noticeable while viewing straight ahead.

In an embodiment utilizing physical materials, the source material can consist of objects such as glass or plastic beads, small broken bits of colored glass, sequins, and/or glitter. These materials are contained in a transparent chamber that may or may not be divided into a series of compartments. The materials can freely move about either dry or suspended in a transparent clear or colored liquid such as water, oil or glycerin. One or more compartments filled with multiple non-mixing insoluble colored liquids may be incorporated, with or without bits of material suspended in them. Compartments without any material in them can also be utilized to serve as dividers or gaps that provide greater depth and separation between those compartments that are filled. The chamber can be physically manipulated, such as being shaken, tilted or rotated, and the material in the chamber can tumble and fall, constantly altering the orientation and physical arrangement of the material observed through the object window.

In another embodiment utilizing stereoscopic video as the source, the mirror box is separated into two channels, one for each eye, with a two-sided mirror as a divider running from between the eyepiece lenses to the object window. This divider prevents one eye from viewing the image intended for the opposite eye. The source material in this embodiment is side-by-side left and right eye parallel-view stereoscopic video or computer generated imagery. The boundaries of the object window's openings correspond to the boundaries of the images.

The stereoscopic video kaleidoscope described herein may also be adapted for use as a stereoscopic 3D viewer. In one embodiment, a stereoscopic 3D viewer is provided for viewing a stereoscopic image having a left side and a right side in a parallel-view format. In another embodiment, a stereoscopic 3D viewer is provided for viewing a stereoscopic image formatted in an over and under manner into top and bottom halves.

Focus adjustments can be provided to accommodate users with varying visual acuity. Adjustments to inter-ocular spacing can also be made to accommodate a wider range of users.

A stereoscopic 3D viewer can additionally be provided with straps or other means of mounting it on a user's head or headgear as to position the viewer before the user's eyes without requiring the user to use his or her hands to hold the viewer. Sensors in the video playback device, such as a compass, accelerometer, gyroscope and/or GPS could track the position, movement and orientation of the user's head and correspondingly update the stereoscopic imagery displayed in real time. This allows the user to use the stereoscopic 3D viewer as virtual reality goggles.

Many other aspects and examples will become apparent from the following disclosure.

### BRIEF DESCRIPTION OF THE DRAWINGS

FIG. 1A is a perspective view from the front of an embodiment of a stereoscopic kaleidoscope utilizing physical objects as source material.

FIG. 1B is a perspective view from the rear of an embodiment of a stereoscopic kaleidoscope utilizing physical objects as source material.

FIG. 1C is an exploded view of an embodiment of a stereoscopic kaleidoscope utilizing with physical objects as source material.

FIG. 1D is a side plan view of an embodiment of a stereoscopic kaleidoscope utilizing physical objects as source material.

FIG. 1E is a top plan view of an embodiment of a stereoscopic kaleidoscope utilizing physical objects as source material.

FIG. 1F is a front plan view of an embodiment of a stereoscopic kaleidoscope utilizing physical objects as source material.

FIG. 2A is a perspective view from the front of an embodiment of a stereoscopic kaleidoscope utilizing stereoscopic video as source material.

FIG. 2B is an exploded view of an embodiment of a stereoscopic kaleidoscope utilizing stereoscopic video as source material.

FIG. 2C is a perspective view from the rear of an embodiment of a stereoscopic kaleidoscope utilizing stereoscopic video as source material.

FIG. 3A is a perspective view from above of the front of an embodiment of a stereoscopic 3D viewer utilizing side-by-side parallel-view formatted stereoscopic video.

FIG. 3B is a perspective view from below of the front of an embodiment of a stereoscopic 3D viewer utilizing side-by-side parallel-view formatted stereoscopic video.

FIG. 3C is an exploded view of an embodiment of a stereoscopic 3D viewer utilizing side-by-side parallel-view formatted stereoscopic video.

FIG. 3D is a front plan view of an embodiment of a stereoscopic 3D viewer utilizing side-by-side parallel-view formatted stereoscopic video.

FIG. 3E is a top plan view of an embodiment of a stereoscopic 3D viewer utilizing side-by-side parallel-view formatted stereoscopic video.

FIG. 3F is a side plan view of an embodiment of a stereoscopic 3D viewer utilizing side-by-side parallel-view formatted stereoscopic video.

FIG. 4A is a perspective view of an embodiment of a stereoscopic 3D viewer utilizing over/under formatted stereoscopic video.

FIG. 4B is a perspective cutaway view of an embodiment of a stereoscopic 3D viewer utilizing over/under formatted stereoscopic video.

FIG. 4C is an exploded view of an embodiment of a stereoscopic 3D viewer utilizing over/under formatted stereoscopic video.

FIG. 4D is a front plan view of an embodiment of a stereoscopic 3D viewer utilizing over/under formatted stereoscopic video.

FIG. 4E is a top plan view of an embodiment of a stereoscopic 3D viewer utilizing over/under formatted streoscopic video.

FIG. 4F is a front plan cutaway view of an embodiment of a stereoscopic 3D viewer utilizing over/under formatted stereoscopic video.

FIG. 4G is a side plan cutaway view of an embodiment of a stereoscopic 3D viewer utilizing over/under formatted stereoscopic video.

FIG. 4H is a diagrammatic side cutout view of the arrangement of the mirrors which form the optics for the viewer.

### DETAILED DESCRIPTION

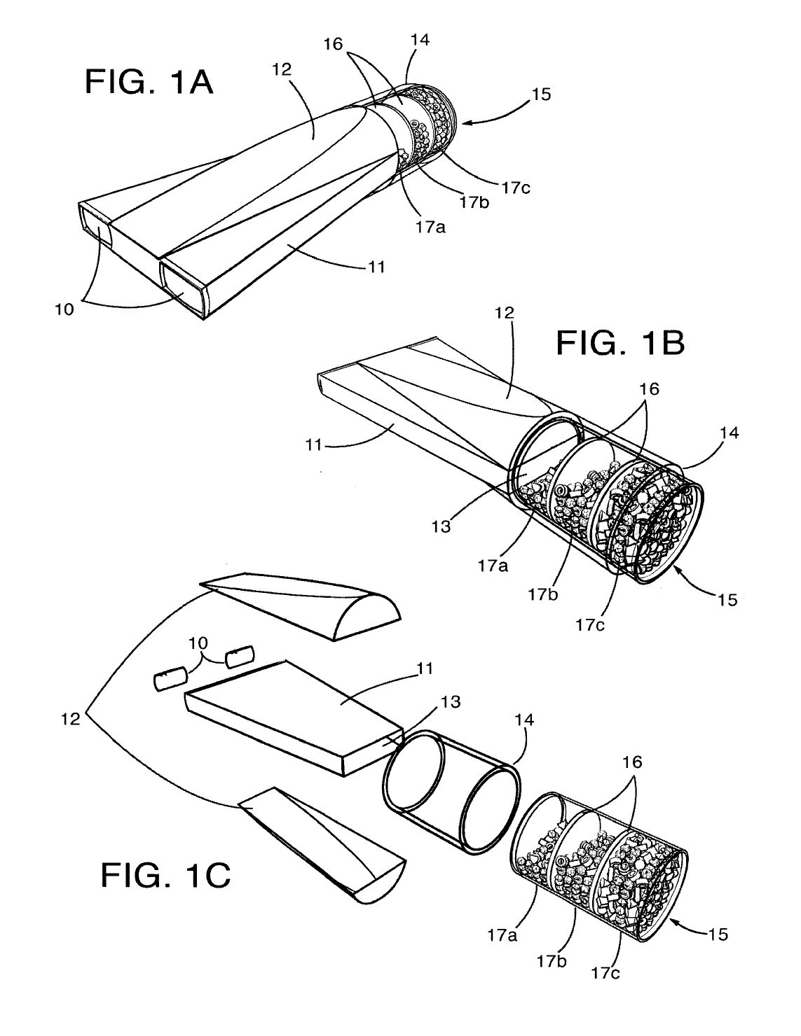

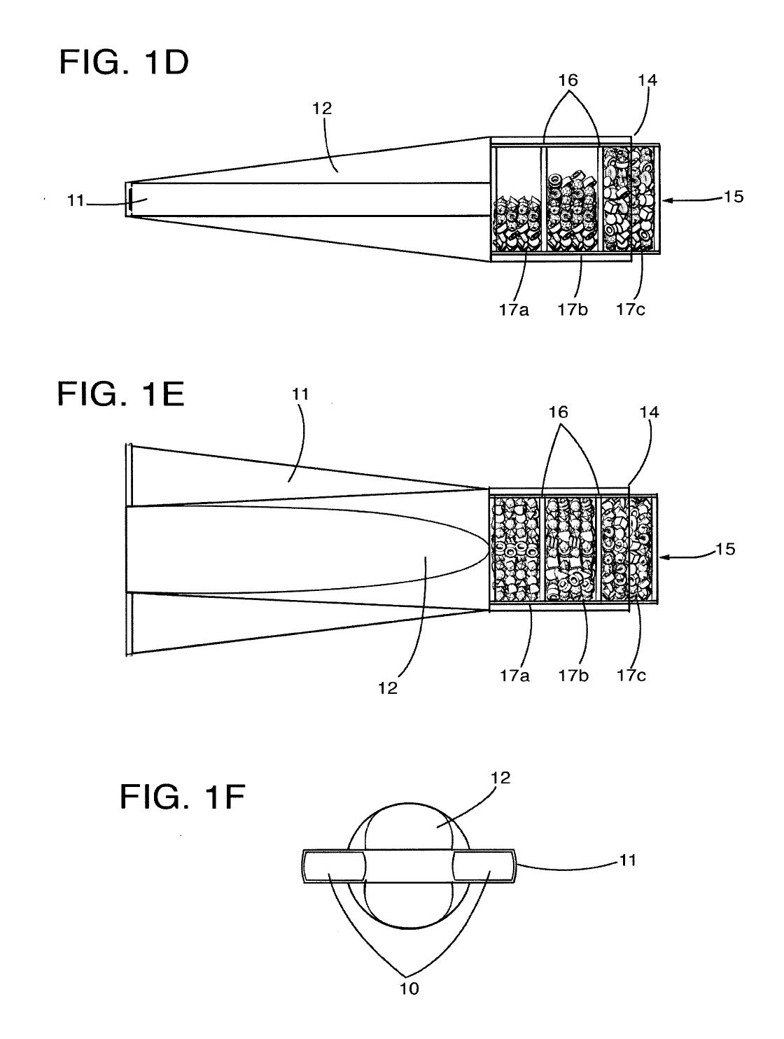

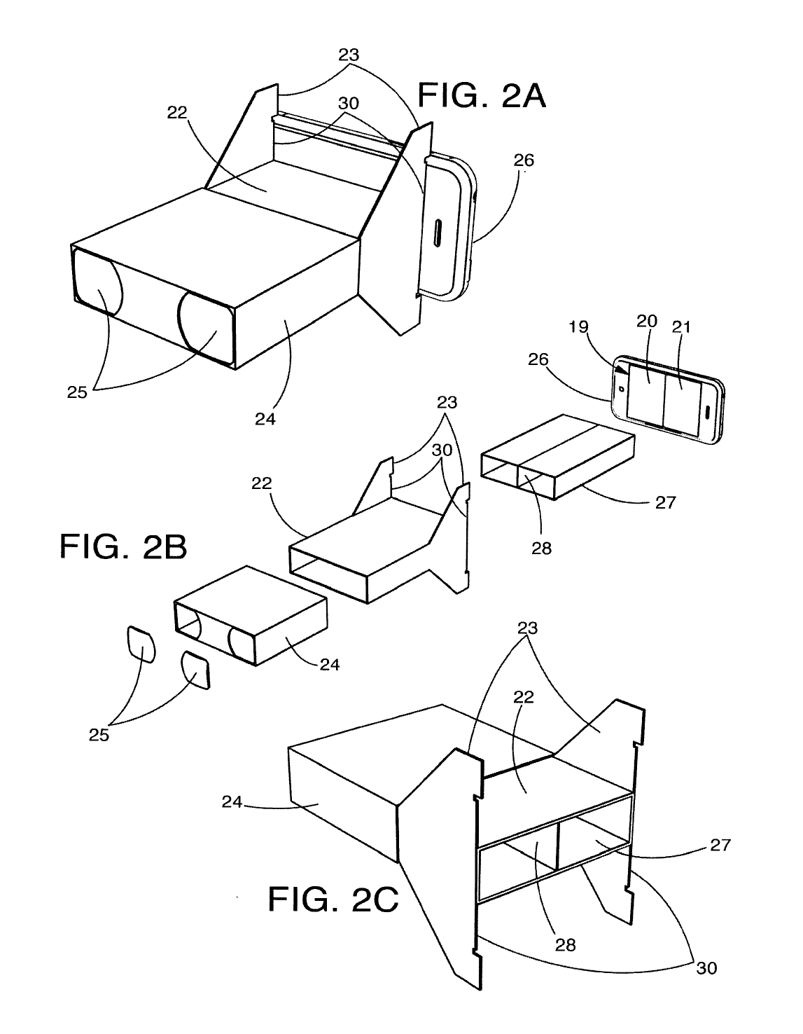

One embodiment of the stereoscopic kaleidoscope utilizing physical objects for source material is illustrated in FIGS. 1A-1F. A mirror box 11 is comprised of four inward reflecting planar mirrored surfaces. At the viewing end of the mirror box 11, the top and bottom surfaces should be wide enough so as not to impede the viewer's peripheral view of the interior reflections. The top and bottom surfaces preferably form trapezoids, converging to a narrower width at an opening 13, which forms an object window. The mirror box 11 can be assembled from four separate reflective surfaces, preferably first surface mirrors, or from a single molded or vacuum formed plastic box that has a mirrorized interior. The top and bottom of mirror box 11 can either be parallel or at a slight angle to the horizontal to one another. Affixed to the mirror box 11 in front of the object window 13 is a transparent cylindrical tube or collar 14, preferably made out of plastic. The diameter of the interior walls of the collar 14 is the same as or wider than the width of the object window 13.

A source material chamber 15 is a cylindrical tube, capped or sealed at both ends, preferably made out of transparent plastic. The interior of the chamber 15 forms a single compartment, or has clear dividers 16, preferably made out of plastic, which separate the interior into two or more compartments, 17a, 17b, and 17c.

The exterior diameter of chamber 15 is slightly less than that of the interior diameter of collar 14 so as to rotate freely when inserted. A portion of chamber 15 is exposed so as to allow manual rotation of it by the user. This can be accomplished by having chamber 15 extend beyond the length of collar 14 as shown in FIGS. 1D & 1E, in which case it can be retained by a lip on the interior of the end of collar 14 and a corresponding groove on the exterior of chamber 15. Alternately, collar 14 can entirely enclose chamber 15 and be capped, in which case collar 14 can have openings in it on opposing sides large enough to allow for manipulation of chamber 15 with a thumb and fingers.

Compartments 17a, 17b, and 17c are filled with an assortment of beads, sequins, glitter, colored non-soluble non-mixing liquids, or other small bits of material which can freely move about when the chamber 15 is manipulated by the user. These objects can reside dry in the compartments 17a, 17b, and 17c or be suspended in clear or colored transparent liquids such as water, oil or glycerin. As shown in side view FIG. 1D, when multiple compartments are filled with objects that are not transparent enough to allow for sufficient viewing through them to the materials in end compartment 17c, the compartment 17a closest to object window 13 is filled with the least amount of material, and subsequent chambers are filled with progressively greater amounts of material, culminating in the end compartment 17c which is filled with the greatest amount of material.

Viewing lenses 10 aid in focusing on the materials in the chamber 15 and are preferably made out of optically transparent plastic. The viewing lenses 10 preferably have a focal length such that their optimum focus point resides at or just beyond the object window 13, and should be far enough apart and of a sufficient diameter so as to accommodate a range of inter-ocular distances from children to adults. Top and bottom housings 12 are affixed to the mirror box 11 so as to support the collar 14.

Another embodiment of the stereoscopic kaleidoscope can incorporate a motor assembly, controlled by one or more buttons or a toggle button or switch, which can rotate the chamber 15 in either a clockwise or counter-clockwise direction according to which button is pressed. The button or buttons can be pressure sensitive so that increasing the pressure applied will increase the speed of the rotation. The motor can rotate chamber 15 by means of friction applied by a wheel in contact with it, preferably made out of rubber, or by a geared wheel, which could engage corresponding gears around chamber 15's outer perimeter.

The stereoscopic kaleidoscope can feature a much longer source material chamber 15 than illustrated in the figures to provide greater separation between compartments and an increased perception of depth. In this case the chamber could be conical rather than cylindrical with a wider diameter at the end opposite the object window, so as to ensure that all of the chambers, including those farthest away from the viewer, cover the entire field of view.

Yet another embodiment of the stereoscopic kaleidoscope can incorporate lighting elements such as LED lights into either the source material chamber or into the interior of the mirror box. These lights could flash or change colors in a pre-programmed sequence. In the mirror box, LEDs could be arranged spaced closely together in rows lining the four corners and/or along a rod positioned in the center of the box from the object window to between the eyepiece lenses. The LEDs can be programmed to fire in sequence so as to produce an animated effect simulating motion, especially motion toward or away from the viewer.

A further embodiment of the stereoscopic kaleidoscope can incorporate another object or source material compartment in the interior of the mirror box, separated from the source material chamber 15. Slots could be cut in the top and bottom of the mirror box to accommodate this compartment. This compartment could be attached to the source material chamber 15 by means of a rod through its center so it would rotate with the others.

The stereoscopic kaleidoscope can feature mechanism whereby chamber 15 can move towards and away from the viewer, preferably oscillating back and forth as it is rotated.

In one embodiment of the stereoscopic kaleidoscope, the source material chamber 15 can feature an “infinity mirror.” The chamber 15 would have a reflective surface, preferably a first surface mirror, at its back facing the viewer, a two-way mirror at its front closest to the object window 13, and be filled with fluorescent colored objects such as beads. These beads could be illuminated by one or more UV LEDs around its perimeter.

In another embodiment the stereoscopic kaleidoscope, the top and bottom mirrors of the mirror box could be hinged where they form the object window instead of fixed so they could assume a variety of angles with respect to one another. This results in the apparent shape of the reflections created changing from a straight vertical wall when the mirrors are parallel, to a curved surface bowing away from the viewer at the object window when the mirrors are angled with a greater separation at the eyepiece lens side. A mechanism, for example, incorporating rods and gears could link the manual rotation of the source material chamber to an oscillating variation of angles so that the apparent shape of the reflections changes over time.

Another embodiment of the stereoscopic kaleidoscope utilizes stereoscopic video as source material and is illustrated in FIGS. 2A-2C. A mirror box 27 seen in FIGS. 2B and 2C is comprised of four inward reflecting planar mirrored surfaces, preferably first surface mirrors. An eyepiece divider 28 bisects and runs the length of the mirror box 27, and has outward reflecting mirror surfaces on both sides. The mirror box 27 is rectilinear, and the length and height of the openings correspond to the exact dimensions of the video material. The mirror box 27 is contained with housing 22, which incorporates panels 23. These panels 23 have indentations 30 which correspond to the narrower outer dimensions of the front of a handheld video playback and computing device 26, such as Apple's iPhone®, in order to allow for correct vertical positioning, alignment and stabilization with it. The user can visually align the sides of the stereoscopic kaleidoscope horizontally to the video screen 29 on the handheld video playback and computing device 26. A lens box 24 slides over housing 22 and is loose enough to allow for repositioning for focus adjustments but tight enough so as not to fall off. The viewing lenses 25 have a focal length focal length sufficient so that their optimum focus point resides at the screen of the handheld video playback and computing device 26.

The housing 22 and the lens box 24 can be made out of various materials such as injection modeled plastic, plastic sheeting, or folded cardboard. The panels 23 can have pre-scored removable notches at regular intervals on either side of the indentations 30 so as to allow the user to increase the size of the indentations 30 to allow for alignment with a variety of widths of handheld video playback and computing devices.

Stereoscopic imagery is formatted for the handheld video playback and computing device 26 in side-by-side, parallel-view format. Parallel-view refers to the placement of the left image on the left side of the screen and the right image on the right side of the screen. The two images are of the same scene but are from two slightly different points of view, and are displayed on video screen 19, as shown in FIG. 2B. The first image, indicated by the reference numeral 20, shows a scene from a left eye's point of view. The second image, indicated by the reference numeral 21, shows the same scene from a right eye's point of view. The amount of distance between these two points of view typically corresponds roughly to the average inter-ocular distance, but can be exaggerated to increase parallax and thus the stereoscopic effect.

The material viewed can include a wide variety of pre-existing stereoscopic content, or be generated in real time, in which case the viewer could interact with the imagery produced by software in a variety of fashions, including pushing buttons, interacting with a touch screen, making noise, or tilting, rotating, or shaking a device that has an accelerometer and/or a compass. In addition, the user's physical location and orientation could be tracked by accelerometer, compass, and/or GPS in the device. The software could respond to this input by changing the program or by altering visual aspects of the imagery such as position, size, color, shape, speed, frequency, or apparent depth.

Another embodiment of the stereoscopic video kaleidoscope may be provided with horizontal panels in addition to vertical panels 23, incorporating indentations that correspond to the wider outer dimensions of the front of the handheld video playback and computing device 26 so that the user does not have to align the two visually. Or instead of panels, a container or other holder can be provided to maintain the video playback device 26 such that it is aligned with the mirror box 27 and such that the user does not have to hold it separately.

The stereoscopic video kaleidoscope described herein may also be adapted for use as a stereoscopic 3D viewer.

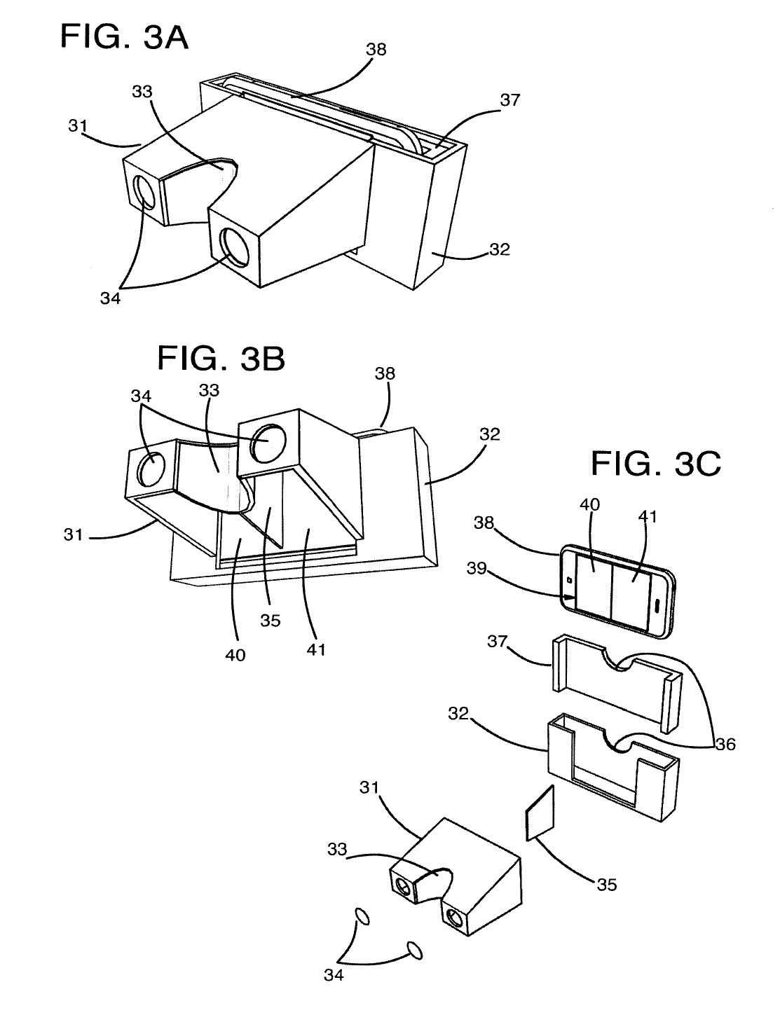

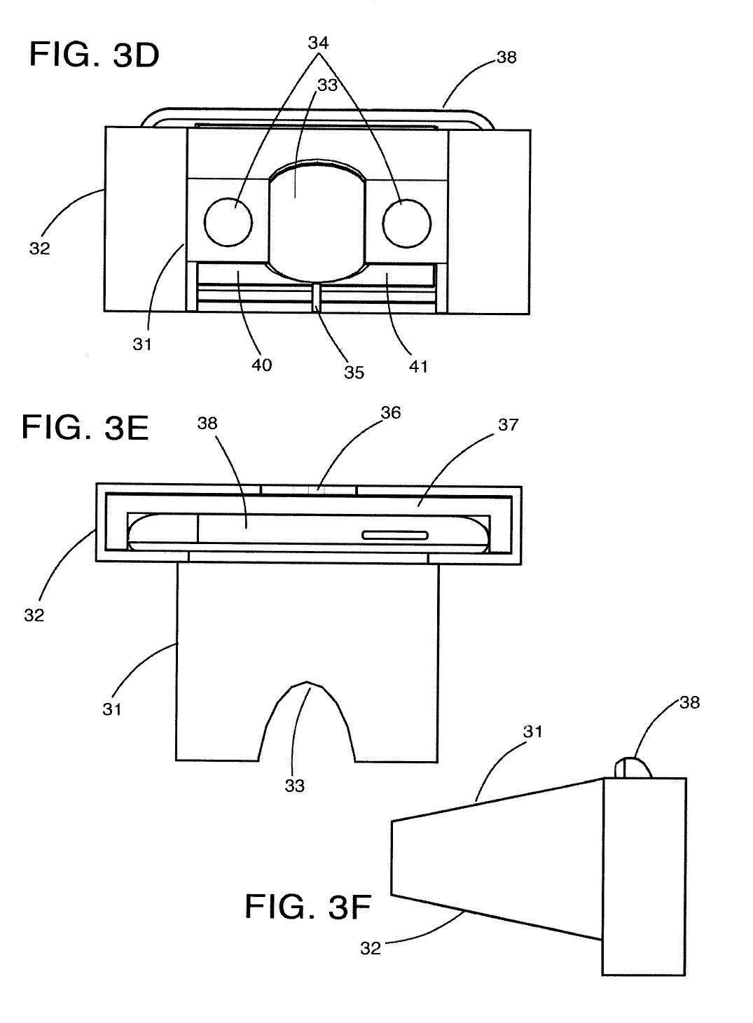

One embodiment of the 3D hand-held video viewer is illustrated in FIGS. 3A-3F and is used with side-by-side parallel-view formatted stereoscopic imagery. Viewing chamber 31 houses eyepiece lenses 34 at the front end and is open at the back and on the bottom. Attached to the viewing chamber 31 is a holder 32 with an opening at the top into which a hand-held video playback and computing device 38 such as Apple's iPhone® can slide. A shell 37, preferably made out of foam rubber, lines the sides and back of the holder 32 so as to seat the hand-held device 38 snuggly and center its alignment to the eyepiece lenses 34, and also allow for a variety of devices with differing dimensions to be accommodated. Thumb notch 36 facilitates easy removal of the device. Set into the viewing chamber 31 is a nose notch 33.

Set into the front surface of the hand-held video playback and computing device 38 is a video screen or monitor 39, which may be a touch-screen. The opening at the back of the viewing chamber 31 corresponds to the dimensions of the video screen 39. The focal length of the eyepiece lenses 34 are such that their optimum focus point corresponds to the distance to the video screen 39.

An eye divider 35 ensures that the left eye only sees left image 40 and the right eye only sees right image 41. The bottom of viewing chamber 31 is open to allow finger-tip access to controls such as buttons or a touch screen on the hand-held video playback and computing device 38.

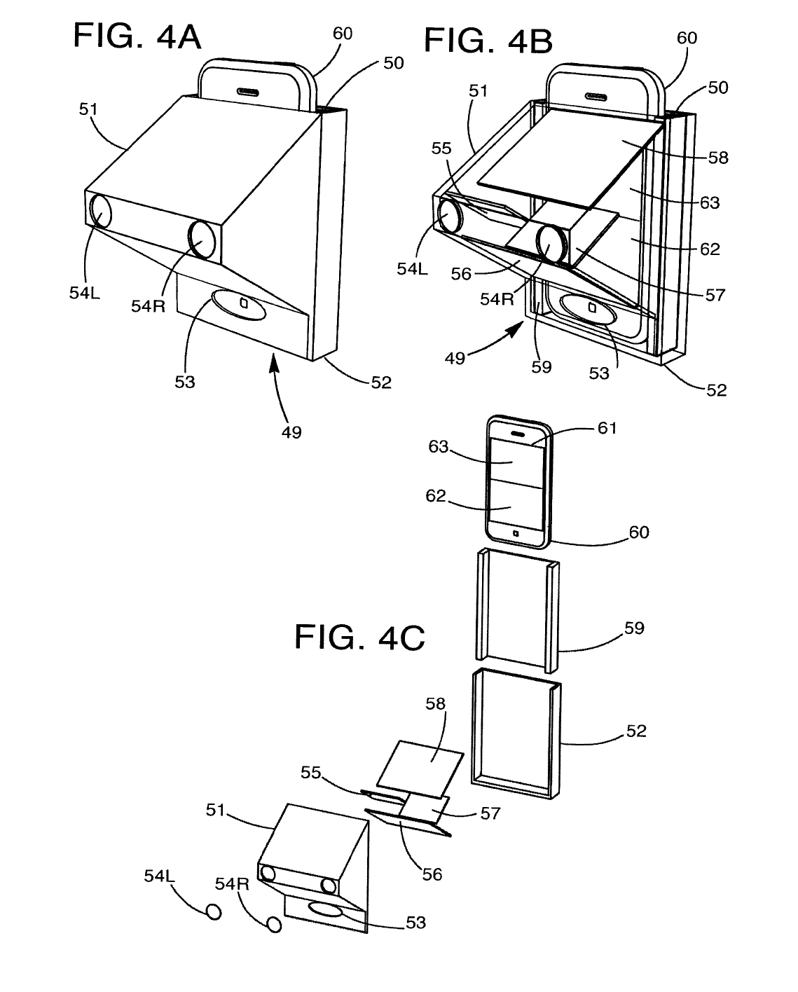

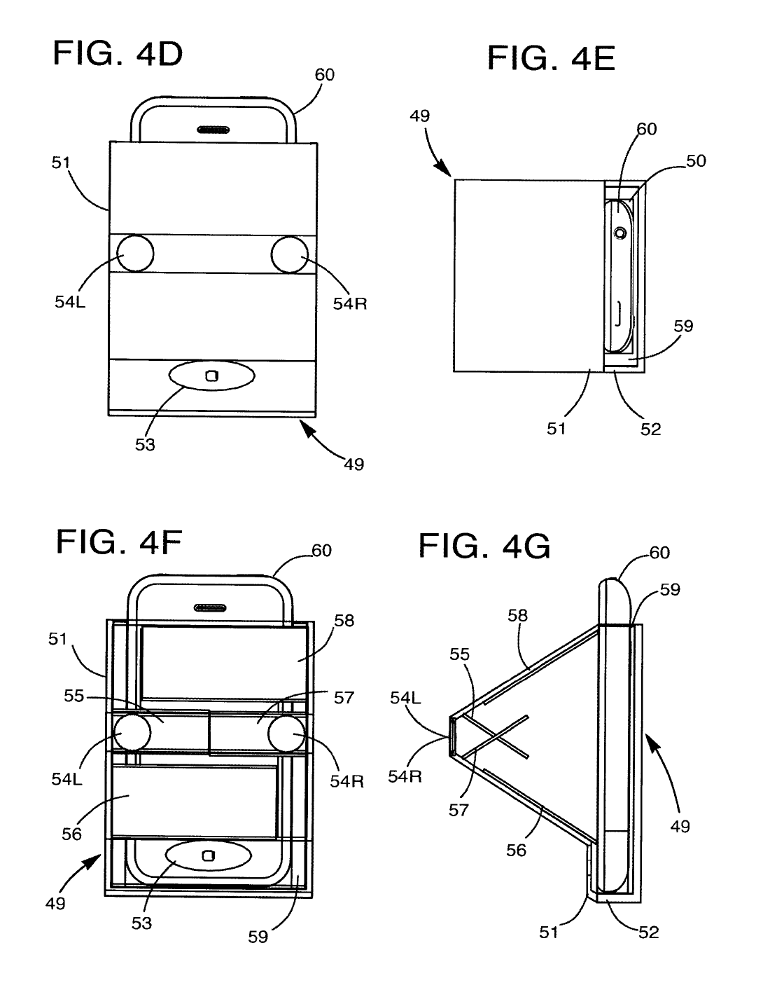

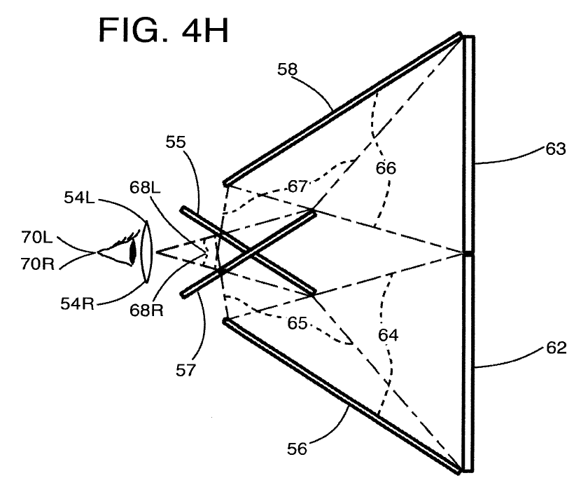

Stereoscopic imagery is formatted for the hand-held video playback and computing device 38 in side-by-side, parallel-view fashion. Parallel-view refers to the placement of the left image on the left side of the screen and the right image on the right side of the screen. The two images are of the same scene but are from two slightly different points of view, and are displayed on video screen 39. The first image, indicated by the reference numeral 40 in FIG. 4C, shows a scene from a left point of view. The second image, indicated by the reference numeral 41, shows the same scene from a right point of view. The amount of distance between these two points of view typically corresponds roughly to the average inter-ocular distance, but can be exaggerated for effect.

The material viewed can include a wide variety of pre-existing stereoscopic content, or be generated in real time such as with video games, in which case the viewer could interact with the imagery. In the case of video games, the user could control the game play produced by software in a variety of fashions, including pushing buttons, interacting with a touch screen, making noise, or tilting, rotating, or shaking a device that has an accelerometer and/or a compass. In addition, the user's physical location and orientation could be tracked by accelerometer, compass, and/or GPS in the device and figure into the game play, particularly in online multi-player games.

In addition to the device being hand held, the device could be mounted to a stand so that it might be placed on a table or other surface, or be mounted to straps or a hat to be worn on the viewer's head so as to position it to the viewer's eyes without requiring the use of the viewer's hands. If the viewer wears the device on his or her head, sensors in the hand-held video playback and computing device 38 such as a compass, accelerometer, gyroscope and/or GPS could track position and orientation of the user's head and correspondingly update the point of view of imagery generated in real time. This would effectively turn the device into very inexpensive virtual reality goggles, and provide for a truly immersive interactive experience.

Another embodiment of the 3D hand-held video viewer is illustrated in FIGS. 4A-4H and is intended for over/under formatted stereoscopic imagery. Housing front 51 and housing back 52 are attached and form the main body of the device 49 with an opening at the top 50 into which a hand-held video playback and computing device 60 such as Apple's iPhone® can slide. An opening 53 may be provided for the user to operate the Home button of the iPhone®. Left eyepiece lens 54L and right eyepiece lens 54R are set into corresponding holes in housing front 51. A shell 59, preferably made out of foam rubber, lines the sides and back of the housing back 52 so as to seat the hand-held device 60 snuggly and center its alignment to the eyepiece lenses 54, and also allow for a variety of devices with differing dimensions to be accommodated.

A mirror assembly is comprised of four planar reflecting surfaces 55-58, preferably front-surface mirrors. A left front mirror 55 is located on the left side of housing front 51 at an angle to the vertical. The left front mirror 55 is optically aligned with the left eyepiece lens 54L so that it can be viewed through the left eyepiece lens 54L. A left rear mirror 56 is located in the left side of housing front 51 at an angle to the vertical and is optically aligned with the left front minor 55. The reflecting faces of the mirrors 55 and 56 are facing each other and parallel with each other as shown in FIGS. 4G and 4H. A right front mirror 57 is located on the right side of housing front 51 at an angle to the vertical. The right front mirror 57 is optically aligned with the right eyepiece lens 54R so that it can be viewed through the right eyepiece lens 54R. A right rear mirror 58 is located on the right side of housing front 51 at an angle to the vertical and is optically aligned with the right front mirror 57. The reflecting surfaces of the mirrors 57 and 58 are facing each other and are parallel with each other as shown in FIGS. 4G and 4H.

The optics of this embodiment are diagrammatically illustrated in FIG. 4H and are designed for optically combining two stereoscopically complementary images displayed on the screen 61 of the hand-held video viewer 60. The images 62 and 63 are arranged in the same vertical plane with the image 63 directly above the image 62 as shown in FIGS. 4B, 4C and 4H. The hand-held video monitor 60 is positioned in the main body 49 so that the right rear mirror 58 is in optical alignment with the upper right-eye image 63 and the left rear mirror 56 is in optical alignment with the lower left-eye image 62. The optical path of the first image 63 extends through the area of dot and dashed line 66 to the reflective surface of the right rear mirror 58. The image 63 is reflected from the reflective surface of the mirror 58 to the reflective surface of the mirror 57 extending along a path which is bounded by the dot and dashed lines 67. The image 63 is reflected a second time from the reflective surface of the right front mirror 57 through the right eyepiece lens 54R along the path which is bounded by the dot and dashed lines 68R to a right eye position 70R. The optical path of the second image 62 extends through the area of dot and dashed line 64 to the reflective surface of the left rear mirror 56. The image 62 is reflected from the reflective surface of the mirror 56 to the reflective surface of the mirror 55 extending along a path which is bounded by the dot and dashed lines 65. The image 62 is reflected a second time from the reflective surface of the left front mirror 55 through the left eyepiece lens 54L along the path which is bounded by the dot and dashed lines 68L to a left eye position 70L.

As shown in FIGS. 4G and 4H, front right mirror 57 extends forward, beyond the optical path bounded by the dot and dashed lines 67 that it is reflecting, so that it's front edge resides in the plane formed by left rear mirror 56. This blocks right eye 70R from viewing any portion of the left eye image 62. Similarly, front left mirror 55 extends forward, beyond the optical path bounded by the dot and dashed lines 65 that it is reflecting, so that it's front edge resides in the plane formed by right rear mirror 58. This blocks left eye 70L from viewing any portion of the right eye image 63.

For both the stereoscopic kaleidoscope and the stereoscopic 3D viewer embodiments, focus adjustments can be provided to accommodate users with varying visual acuity. In addition, adjustments to inter-ocular spacing can also be made to accommodate a wider range of users.

The above disclosure provides examples and aspects relating to various embodiments within the scope of claims, appended hereto or later added in accordance with applicable law. However, these examples are not limiting as to how any disclosed aspect may be implemented, as those of ordinary skill can apply these disclosures to particular situations in a variety of ways.

1. A kaleidoscope comprising: a mirror box having a proximal end and a distal end,
wherein the proximal end has a width sufficiently wide to allow a user of the kaleidoscope to use both eyes to look through the minor box,
a first inward-facing mirror extending between the proximal end and the distal end of the mirror box, a second inward-facing mirror facing the first inward-facing mirror and extending between the proximal end and the distal end of the mirror box,
a collar attached to the distal end of the mirror box, and
a source material chamber containing three-dimensional objects provided within the collar, wherein the source material chamber is adapted for rotation within the collar.

2. The kaleidoscope of claim 1, further comprising lenses provided at the proximal end of the minor box for both eyes of the user of the kaleidoscope.

3. The kaleidoscope of claim 2, wherein each lens have a focal point at the distal end of the mirror box.

4. The kaleidoscope of claim 2, wherein each lens have a focal point distal to the distal end of the mirror box.

5. The kaleidoscope of claim 1, wherein the three-dimensional objects are suspended within a liquid in the source material chamber.

6. The kaleidoscope of claim 1, wherein the three-dimensional objects comprises two or more non-mixable liquids.

7. The kaleidoscope of claim 1, wherein the source material chamber is divided into two or more compartments.

8. The kaleidoscope of claim 7, wherein the three-dimensional objects are contained within one or more compartments.

9. The kaleidoscope of claim 7, wherein a distal compartment contains more three-dimensional objects than a proximal compartment.

10. The kaleidoscope of claim 7, wherein at least one compartment is free of three-dimensional objects.

11. The kaleidoscope of claim 1, further comprising:
a third inward-facing mirror extending between the proximal end and the distal end of the mirror box, and
a fourth inward-facing mirror facing the third inward-facing mirror and extending between the proximal end and the distal end of the mirror box,
wherein the mirror box has a rectangular cross-section formed by the first inward-facing mirror, the second inward-facing mirror, the third inward-facing mirror, and the fourth inward-facing mirror.

12. The kaleidoscope of claim 1, wherein the mirror box tapers from the proximal end to the distal end.

13. The kaleidoscope of claim 11, wherein the mirror box tapers from the proximal end to the distal end.

14. The kaleidoscope of claim 1, further comprising a motor adapted for rotating the source material chamber within the collar.

15. The kaleidoscope of claim 1, further comprising a mechanism adapted for sliding the source material chamber within the collar away from or towards the distal end of the mirror box.

16. The kaleidoscope of claim 1, further comprising a light source for illuminating the mirror box.

17. The kaleidoscope of claim 1, further comprising a light source for illuminating the source material chamber.

18. The kaleidoscope of claim 1, further comprising:
a mirror provided at a distal end of the source material chamber facing the mirror box, and
a two-way mirror provided at a proximal end of the source material chamber facing the distal end of the source material chamber which allows the user to see into the source material chamber.

19. A kaleidoscope comprising:
a mirror box with a rectangular cross-section having a proximal end and a distal end,
four inward-facing mirrors extending between the proximal end and the distal end of the mirror box,
a divider extending between the proximal end and the distal end of the mirror box and bisecting the mirror box into a left half and a right half the divider having two outward-facing mirrors which are parallel to two of the four inward-facing mirrors,
a display capable of displaying a stereoscopic image having a left side and a right side in a parallel-view format, and
a holder adapted for aligning the display to the mirror box,
wherein the left half of the mirror box is aligned with the left half of the stereoscopic image,
and the right half of the mirror box is aligned with the right half of the stereoscopic image.

20. The kaleidoscope of claim 19, further comprising:
a left lens provided at the proximal end of the left half of the mirror box for viewing the left half of the stereoscopic image, and
a right lens provided at the proximal end of the right half of the mirror box for viewing the right half of the stereoscopic image.

21. The kaleidoscope of claim 19, further comprising a lens box adapted to slide over the proximal end of the mirror box, the lens box further comprising:
a left lens provided at the proximal end of the lens box for viewing the left half of the stereoscopic image, and
a right lens provided at the proximal end of the lens box for viewing the right half of the stereoscopic image.

22. The kaleidoscope of claim 19, wherein the display displays the stereoscopic image in a series of stereoscopic images.

23. The kaleidoscope of claim 19, wherein the display displays the stereoscopic image as a part of a stereoscopic video.

24. The kaleidoscope of claim 19, wherein the stereoscopic image changes as a result of a user's input.

25. A kaleidoscope comprising:
a left mirror box having a proximal end and a distal end,
a right mirror box having a proximal end and a distal end,
each mirror box additionally comprising four inward-facing mirrors extending between the proximal end and the distal end of the minor box,
a display capable of displaying a stereoscopic image having a left side and a right side in a parallel-view format, and
a panel adapted for aligning the display to the left mirror box and the right mirror box,
wherein the left minor box is aligned with the left half of the stereoscopic image,
and the right mirror box is aligned with the right half of the stereoscopic image.

26. A binocular viewer, comprising:
a left front minor,
a left rear mirror,
a right front minor, and
a right rear minor,
wherein a top half of an image is reflected by the right rear mirror onto the right front mirror and into a right eye of a user of the binocular viewer, and
a bottom half of the image is reflected by the left rear minor onto the left front minor and into a left eye of the user.

27. A binocular viewer, comprising:
a left front mirror,
a left rear minor,
a right front minor, and
a right rear minor,
wherein a top half of an image is reflected by the left rear mirror onto the left front mirror and into a left eye of a user of the binocular viewer, and
a bottom half of the image is reflected by the right rear mirror onto the right front mirror and into a right eye of the user.

28. The binocular viewer of claim 26, wherein the image is a stereoscopic image formatted in an over and under manner into top and bottom halves.

29. The binocular viewer of claim 27, wherein the image is a stereoscopic image formatted in an over and under manner into top and bottom halves.

30. The binocular viewer of claim 26, further comprising:
a left lens, and
a right lens,
wherein the top half of the image is reflected by the right rear mirror onto the right front mirror through the right lens and into the right eye of the user,
and the bottom half of the image is reflected by the left rear mirror onto the left front mirror through the left lens and into the left eye of the user.

31. The binocular viewer of claim 27, further comprising:
a left lens, and
a right lens,
wherein the top half of the image is reflected by the left rear mirror onto the left front mirror through the left lens and into the left eye of the user,
and the bottom half of the image is reflected by the right rear mirror onto the right front mirror through the right lens and into the right eye of the user.

32. The binocular viewer of claim 26, wherein the left front mirror is parallel to the left rear mirror and the right front mirror is parallel to the right rear mirror.

33. The binocular viewer of claim 27, wherein the left front minor is parallel to the left rear mirror and the right front minor is parallel to the right rear mirror.
